(19) United States
(12) Patent Application Publication
(10) Pub. No.: US 2025/0383365 A1
(43) Pub. Date: Dec. 18, 2025

(54) ANALYTICAL INSTRUMENT HAVING A SYRINGE SIZE IDENTIFICATION FUNCTIONALITY

(71) Applicant: Tecan Trading AG, Männedorf (CH)

(72) Inventors: Robert Claude AUTREY, Lenexa, KS (US); Benjamin Wayne MORGAN, JR., Boulder Creek, CA (US)

(21) Appl. No.: 19/233,994

(22) Filed: Jun. 10, 2025

(30) Foreign Application Priority Data
Jun. 14, 2024 (EP) 24 182 180.0

(51) Int. Cl. G01N 35/00; G01N 35/10

(52) U.S. Cl. CPC G01N 35/00732; G01N 35/1016; G01N 2035/00772; G01N 2035/1025

(57) ABSTRACT

An analytical instrument having a syringe size identification functionality includes a syringe pump with syringe having size V_{syri}, an electric drive, a valve downstream of the syringe, a pressure sensor between the syringe and the valve, a constant downstream volume V_{c} and a processor configured to control the electric drive to move the plunger from L₀ for detecting pressure P1 to a pressure detection position L_{d} for detecting P2 using the pressure sensor. The processor is configured to calculate the theoretical pressure P2* using a modified version of Boyle's law: P2*=P1(V_{syri}+V_{c})/(V_{syri}(1−x)+V_{c}) and compare the theoretical pressure P2* with the detected pressure P2. When the theoretical pressure P2* equals the detected pressure P2, the analytical system is released for use.

### FIELD OF THE INVENTION

The current invention relates to an analytical instrument with a syringe pump and the instrument is provided with a syringe size identification functionality. A method for detecting the size of a syringe in the analytical instrument and a computer program for detecting the size of a syringe in the analytical instrument are disclosed.

### BACKGROUND OF THE INVENTION

Analytical instruments such as laboratory automation apparatuses or diagnostic testing devices use liquid handling devices for preparing, or supplying the liquids required for operating the apparatuses. The liquid handling devices may include valves and pump units.

The diagnostic testing device may include, for example, High Performance Liquid Chromatography (HPLC), Gas Chromatography (GC), Mass Spectrometry (MS) devices or a combination thereof. An example for a laboratory automation apparatus may be a dilutor, a pipetting device or a sample preparation device such as a Solid Phase Extraction apparatus (SPE). Another example of a laboratory automation apparatus may be a synthesizer used for facilitating the synthesis of chemical molecules such as small molecules, peptides and/or large molecules such as DNA or RNA strands. Yet another example of a laboratory automation apparatus may be include a DNA sequencer. The laboratory automation apparatus may include a robotic system for sample loading or transport of labware and the robotic system may include a robotic pipetting system for aspirating and dispensing liquids.

The pump unit may include a syringe pump for providing the liquid supply in the analytical instrument including a syringe with a plunger that may be retracted or advanced in the syringe by a plunger rod driven by an electro-mechanical drive. The electro-mechanical drive typically includes an electric motor such as a stepper motor. A typical syringe pump requires the user to program in a desired volume for aspiration and/or dispense by specifying the number of steps the pump stepper motor takes for each syringe size. This requires the user to know the syringe dimensions such as the internal diameter and to calculate the number of steps required for each syringe size. When the size of the syringe in the syringe pump is changed, this would require the user to recalculate the number of steps the motor takes to obtain the desired volumes, for example a syringe with a larger diameter requires less steps compared to a syringe with a smaller diameter for dispensing the same volume. The user may have to manually adjust the parameters in the analytical instrument when changing the syringe in the syringe pump.

US20210121885A1 discloses a syringe identification system for use with a handheld positive displacement pipette including a color sensor that can detect the color printed onto the outside surface of a syringe that can be installed in the pipette. The color is unique to the syringe and a controller in the pipette is programmed to automatically set or adjust one or more operating parameters of the pipette based on the identified syringe size which is linked to the color coding.

### DESCRIPTION OF THE INVENTION

The manual adjustment of the instrument parameters may lead to errors in the liquid handling when the programmed number of steps for the stepper motor for pumping a desired liquid volume is not matched with the installed syringe size. Furthermore, optical recognition of the syringe size using color coded syringes requires additional color sensors, dedicated lightning for illuminating the color codes that need to be additionally printed onto the syringe. This may increase the complexity of the device, add or modify the hardware components and increase the costs of the product.

It is an objective of the present invention to overcome the disadvantages of the prior art and provide an analytical instrument with an automatic syringe size identification functionality using the existing firmware without adding additional components. It is an objective to provide a simple method for detecting the size of a syringe in the analytical instrument using the existing firmware and finally a computer program is provided for executing the method.

Those objectives are solved by the independent claims, further exemplary embodiments are evident from the dependent claims and the following description including the Figures.

A first aspect relates to an analytical instrument or laboratory automation apparatus having a syringe size identification functionality. The analytical instrument includes a syringe pump with a syringe having size V_{syri}, an electric drive, a valve downstream of the syringe, a pressure sensor between the syringe and the valve, a constant downstream volume V_{c}, and a processor configured to control the electric drive to move the plunger from L₀ for detecting pressure P1 to a pressure detection position L_{d} for detecting P2 using the pressure sensor. The processor is configured to calculate the theoretical pressure P2* using a modified version of Boyle's law: P2*=P1(V_{syri}+V_{c})/(V_{syri}(1−x)+V_{c}) and compare the theoretical pressure P2* with the detected pressure P2, if the theoretical pressure P2* equals the detected pressure P2 then release the analytical system for use.

The analytical instrument includes a syringe pump with an installed syringe having a size or volume V_{syri}. The analytical system further includes an electric drive for advancing or retracting a plunger in the syringe, a valve located downstream of the syringe and a pressure sensor located between the syringe and the valve. Downstream is defined here by the flow direction of a the liquid or gas, thus the direction of fluid entry is upstream whereas the direction of fluid discharge is downstream. The downstream or dead volume between the syringe or the outlet of the syringe and the valve defines a known and constant volume V_{c}. A control unit including a controller with a processor is operatively connected to the valve, the pressure sensor and the electric drive. The control unit provides control over the closure or opening of the valve and the control unit may receive and monitor the signals from the sensor for detecting the pressure in the syringe. The control unit may control the electric drive for pressurizing or depressurizing the syringe by advancing or retracting the plunger in the syringe. The control unit may include a storage unit for storing data, the data may be factory installed and predefined, or the data may be computed and stored in the unit during use of the instrument. The processor in the control unit is configured to control the electric drive for advancing the plunger from a position L₀ for detecting atmospheric pressure or a first pressure P1 of air or another gas, to a pressure detecting position L_{d} for detecting the pressure of the compressed gas using the pressure sensor. The processor is further configured to calculate the fraction x for the plunger movement to the pressure detection position L_{d} as: x=(L_{d}−L₀)/Lₘₐₓ whereby Lₘₐₓ represents the maximum available plunger movement provided by the electric drive or the maximum available plunger movement available in the barrel of the syringe before reaching a hard stop. The theoretical pressure P2* for the plunger movement to the pressure detection position L_{d} is computed for the installed syringe V_{syri} by the processor using a non-linear modification of Boyle's law:

$$P {2}^{*} = P 1 ( {V}_{syri} + {V}_{c} ) / ( {V}_{syri} ( 1 - x ) + {V}_{c} )$$

Pressure P1 may be atmospheric pressure or an elevated pressure that is below the pressure value P2. The control unit may store the theoretical pressure P2* in the storage unit and the processor may furthermore compare the theoretical pressure P2* with the detected pressure P2. The control unit is configured to release the analytical system or instrument if the theoretical pressure P2* equals the detected pressure P2 for the installed syringe V_{syri} and the instrument is ready for use. The release may be a release from a blocked position or configuration where the user cannot or at least partially cannot use the instrument. Alternatively, the release involves notifying to the user via the user interface that the instrument is ready for use. The processor in the control unit is configured to compare the detected pressure P2 with a lookup table stored in the storage device of the control unit, the lookup table comprises theoretical pressures P2** attributed to a list of different syringe sizes V_{syr} intended to be used in the syringe pump if the theoretical pressure P2* deviates or substantially deviates from the detected pressure P2. The deviation between the detected pressure P2 and the calculated theoretical pressure P2* is preferably above the tolerance level of the pressure sensor used. If the theoretical pressure P2* deviates or substantially deviates from the detected pressure P2 then the syringe pump is recalibrated by adjusting the parameters for the electric drive according to the syringe size V_{syr} where there is a match between the theoretical pressures P2** from the lookup table and the detected pressure P2. The theoretical pressures P2** are calculated according to the modified Boyle's equation as listed above whereby the constant volume V_{c} is added to the volume of each syringe V_{syr}: P2**=P1(V_{syr}+V_{c})/(V_{syr}(1−x)+V_{c}). The syringe sizes V_{syr} are selected from a range of syringes intended to be used in the analytical instrument.

The constant volume V_{c} provides a non-linear modification to the Boyle's equation when comparing different syringe sizes. The ratio between the constant volume V_{c} and the syringe volume V_{syr} defines the impact of the constant volume V_{c} on the modified Boyle's equation and to what extend the additional volume can differentiate between the different syringe sizes in a range of syringe sizes.

The analytical system or apparatus having the syringe size identification functionality utilizes the available hardware/software of the instrument without adding additional components such as optical sensors and color-coded products and therewith provides a simple method for identifying the syringe size, and where needed, for correcting the drive parameters for the syringe pump. The syringe size identification utilizes air for determining the syringe size and this is readily available before filling the syringe pump with the liquid normally used in the instrument. Furthermore, the syringe identification step can be automatically executed and does not require manual correction of the syringe size reducing human errors when using the instrument.

The plunger in the syringe of the syringe pump is advanced by a plunger rod driven by the electric drive and the electric drive includes an electric motor and may include a gearing mechanism coupling the output shaft of the electric motor to the plunger rod. The plunger may be attached to the distal end of the plunger rod and the plunger tightly fits into the barrel of the syringe for an air- and/or liquid-tight closure of the syringe. The plunger rod may be advanced by a nut-and-bolt mechanism whereby either the nut is rotated by the electric drive for advancing a non-rotating plunger rod including the bolt, or alternatively, the threaded plunger rod is rotated as a bolt and advanced through a non-rotating nut. The electric motor may be a stepper motor, for example a Direct Current (DC) stepper motor, or a brushless DC motor or a linear motor.

In an embodiment, the forward movement of the plunger rod in the analytical instrument is controlled by the number of commutating steps directed to the stepper motor thereby defining a pressure sweep P2-P1 and the number of commutating steps required for the pressure sweep is listed in the lookup table for each syringe size V_{syr} from the range of syringe sizes intended to be used in the instrument. The number of commutating steps defines the number of rotations of the output shaft of the electric motor and defines, via the optional gearing mechanism and/or nut-bolt mechanism, the linear advancement of the plunger rod towards the pressure detection position L_{d}.

The recalibration of the syringe pump may include linking the number of commutating steps to be directed to the electric motor to the specific syringe size V_{syr} from the listed syringe sizes where there is a match between the theoretical pressures P2** and the detected pressure P2. As a consequence, the pressure sweep defined by the advancement of the plunger in the syringe is corrected. Thus for the installed syringe with volume V_{syri}, the detected pressure P2 by the pressure sensor may deviate from the calculated pressure P2* based on the plunger advancement using the drive parameters before correction. The linear advancement originally programmed may not fit to the installed syringe size V_{syri} as this would lead immediately to a match between the detected pressure P2 and the calculated pressure P2*. The look-up table with a list of calculated pressure values P2** that are each linked to a different syringe size, and which are each linked to the correct number of commutating steps for the stepper motor, is used for correcting the drive mechanism to the size of the installed syringe.

The syringe in a syringe pump may have to be exchanged either due to normal wear (for example when the pump is leaking) or if the user intends to replace the installed syringe for a syringe with a different size. The user may install a syringe with a different size compared to the previously installed syringe and the automatic recalibration ensures safe and reliable operation of the syringe pump and therewith contribute to the safe and reliable operation of the instrument The analytical instrument may further include an automatic syringe leakage detecting system.

The known and constant volume V_{c} may be defined by the tubing or connectors connecting the syringe to the valve, the dead volume in the valve and the dead volume in the pressure sensor. The constant volume is in principle constant for the range of syringes to be installed in the instrument. The constant volume V_{c} may be adjusted such that a larger constant volume may be used in combination with a different range of larger syringes and a smaller constant volume may be used in combination with a different range of smaller syringes. The syringe size identification functionality may thus be operated under optimal conditions for both ranges as the ratio between the constant volume and the installed syringe volume is preferably greater then 0.05 more preferably greater then 0.1 and most preferably greater than 0.2.

The syringe pump in the analytical system may be automatically recalibrated if the theoretical pressure P2* deviates from the detected pressure P2. Thereby providing safe and accurate operation of the syringe pump.

The syringe pump is preferably filled with air or a different gas such as nitrogen for the syringe size identification testing before being filled with the liquid normally used in the analytical apparatus. The syringe pump is filled with a gas as this ensures that the non-linear modification of Boyle's equation can be used for the syringe identification testing.

The syringe size identification testing in the analytical system or instrument may be periodically performed or performed upon replacing the syringe in the syringe pump.

The control unit of the analytical system may be configured to issue an acoustic and/or visual alarm if the theoretical pressure P2* deviates from the detected pressure P2 and/or the controller may issue an acoustic and/or visual notification if the theoretical pressure P2* equals the detected pressure P2. The results for the testing, whether upon replacement of the syringe, during periodic testing, or automatic testing upon starting the system may be stored in a logbook of the storage unit of the controller.

The syringe size in the analytical instrument may vary between 10 μl and 50.000 μl. The pressure sensor is preferably installed downstream of the outlet of the syringe, the pressure sensor may be incorporated in the valve, for example in a stator of a rotary valve.

The controller may monitor the motor current (MC) that is used by the stepper motor for keeping the plunger in the pressure detection position L_{d}. The stepper motor of the electric drive advances the plunger rod in the syringe from an initial position L₀ where there is pressure P1, for example atmospheric pressure, in the syringe to a pressure detection position L_{d} thereby pressurizing the air in the syringe to pressure P2 as the valve is closed. The compressed air in the syringe provides a reaction force on the plunger, on the plunger rod and on the electric drive that needs to be compensated for keeping the plunger in the pressure detection position. The reaction force can be calculated by multiplying the detected pressure P2 (in N/mm²) with the surface area A (in mm²) of the plunger or by multiplying the detected pressure P2 with the cross-sectional surface area of the barrel of the syringe. The detection of the motor current may provide a second indication of the pressure within the syringe. A higher reaction force may require a higher motor current value MC for keeping the plunger rod in the pressure detection position L_{d}. The motor current required, or the theoretical motor current required for a certain syringe size may be stored in the storage unit and may be part of the factory settings.

The lookup table stored in the storage unit may include predefined motor current values MC* that are attributed to each syringe size V_{syr} and the syringe pump may be recalibrated if:
a) the received motor current MC deviates from the predefined motor current value MC*, and/or
b) when the difference in theoretical pressures P2** in the lookup table between two subsequent syringe sizes V_{syr} is in the same order of magnitude as the tolerance value of the pressure sensor.

For example, the pressure sensor used may have a tolerance value of +/−0.1 Bar and the difference in theoretical pressures between two subsequent syringe sizes may be 0.1 to 0.3 Bar, and in that case using the syringe size identification solely based on the pressure sensor may become less reliable. The motor current MC detected for keeping the plunger in the pressure detection position may be used for identifying the correct syringe size.

The recalibration of the syringe pump using the motor current includes attributing or linking the number of commutating steps of the electric motor to the syringe size V_{syr} where there is a match between the predefined motor current value MC* and the received motor current value MC.

Another aspect of the invention relates to a method for detecting the size of a syringe in an analytical instrument whereby the analytical instrument includes a syringe pump with an installed syringe having a volume V_{syri}, a valve located downstream of the syringe, a pressure sensor located between the valve and the syringe, a known and constant volume V_{c} representing the downstream volume between the syringe and the valve, an electric drive for advancing or retracting a plunger in the syringe and a control unit comprising a processor for controlling the analytical instrument. The method includes the following steps:
providing air or another gas in the syringe pump at atmospheric pressure P1,
closing the valve,
moving the plunger in the syringe with volume V_{syri} using the electric drive from a starting position L₀ for detecting atmospheric pressure P1 to a pressure detection position L_{d} for detecting pressure P2 using the pressure sensor,
using the processor to calculate the fraction x for the plunger movement as x=(L_{d}−Lₒ)/Lₘₐₓ whereby Lₘₐₓ represents the maximum available plunger movement in the syringe,
using the processor to calculate the theoretical pressure P2** for the given plunger movement for different syringe sizes V_{syr} configured to be used in the analytical instrument using the same constant volume V_{c} from the above non-linear modification of Boyle's law as:

$$P {2}^{* *} = P 1 ( {V}_{syr} + {V}_{c} ) / ( {V}_{syr} ( 1 - x ) + {V}_{c} )$$

preparing a list of the theoretical pressures P2** for the different syringe sizes V_{syr} and optionally store the list in a lookup table in a storage device in the control unit,
comparing the theoretical pressures P2** for the given plunger movement for the different syringe sizes V_{syr} with the detected pressure P2 for the installed syringe having volume V_{syri}, and,
   identify the syringe size V_{syr} with a theoretical pressure P2** that equals the detected pressure P2 for the installed syringe V_{syri}, and automatically recalibrate the syringe pump by adjusting the parameters for the electric drive driving the syringe pump according to the identified syringe size using the lookup table if the theoretical pressure P2** deviates from the detected pressure P2. The pressure P1 may be atmospheric pressure or a starting pressure P1 during plunger movement that is below the pressure level P2.

The method wherein the plunger in the syringe is advanced by a plunger rod driven by the electric drive comprising a stepper motor and the forward movement of the plunger rod is controlled by the number of commutating steps directed to the stepper motor thereby defining a pressure sweep P2−P1 and the number of commutating steps required for the pressure sweep is listed in the lookup table for each syringe size V_{syr}.

Adjusting the parameters for driving the syringe pump includes linking the number of commutating steps of the electric motor of the electric drive to the syringe size V_{syr} where there is a match between the theoretical pressures P2** and the detected pressure P2 using the lookup table thereby correcting the pressure sweep.

The controller of the control unit may additionally or complementary monitor the motor current MC used by the stepper motor for keeping the plunger in the pressure detection position L_{d} and the lookup table may include predefined motor current values MC* that are attributed to each syringe size V_{syr} for the keeping the plunger in the pressure detection position. The syringe pump is recalibrated a) if the received motor current MC deviates from the predefined motor current value MC* and/or b) when the difference in theoretical pressures P2** in the lookup table between two subsequent syringe sizes V_{syr} is in the same order of magnitude as the tolerance level of the pressure sensor.

The method wherein recalibration the syringe pump includes attributing the number of commutating steps for the electric motor to the syringe size V_{syr} where there is a match between the predefined motor current value MC* and the received motor current value MC by the processor.

Another aspect of the invention relates to a computer program for detecting the size of a syringe in an analytical instrument, the computer program when executed by the processor that is part of the analytical instrument is adapted to execute the previously described method steps.

Another aspect relates to a computer readable medium in which the computer program is stored. The computer readable medium may be a disc, USB stick or a hard drive. The computer readable medium may be part of a cloud solution.

### BRIEF DESCRIPTION OF THE DRAWINGS

Embodiments of the present invention are described in more detail with reference to the attached drawings presenting:

FIG. 1: Schematic representation of an analytical instrument having a syringe size identification functionality,

FIG. 2a: Schematic drawing of a syringe pump with a syringe, an electric drive, a valve, a pressure sensor connected to the outlet of the syringe with a constant volume V_{c} between the syringe outlet and the valve. The syringe pump being filled with air at atmospheric pressure and the plunger at initial position L₀,

FIG. 2b: Syringe pump of FIG. 2a with closed valve, the plunger has been moved to the pressure detection position L_{d} by the electric drive,

FIG. 3: Syringe pump of FIG. 2a after replacement of the syringe with a different size,

FIG. 4: Longitudinal section of a rotary valve,

FIG. 5: Cross sectional view of the rotary valve of FIG. 4, valve in open position,

FIG. 6: Cross sectional view of the rotary valve of FIG. 4, valve in closed position,

FIG. 7: Theoretical pressure P2** for a range of syringe sizes,

FIG. 8: Reaction force for retaining the plunger in the pressure detection position,

FIG. 9: Block diagram for the method for detecting the size in the analytical instrument.

### DETAILED DESCRIPTION OF EXEMPLARY EMBODIMENTS

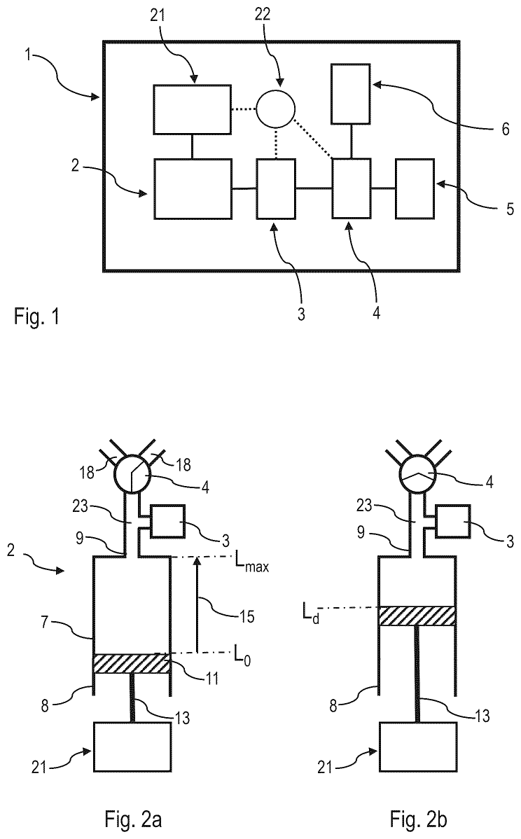

FIG. 1 shows a schematic representation of an analytical instrument 1 with a syringe identification functionality with a syringe pump 2, a pressure sensor 3 and a valve 4. The syringe pump 2 may be prefilled or may be fluidly connected to a container providing the liquid supply. The syringe pump 2 is driven by an electric drive 21 which includes an electric motor, for example a stepper motor. The electric drive may include a gearing mechanism for gearing up or gearing down the rotation of the drive axle of the electric motor. The pressure sensor 3 is located between the valve 4 and an outlet of the syringe pump 2. The valve 4 may be a multi-port valve for selecting between, for example, a waste container 6 or fluidly connecting the syringe pump 2 to a testing device such as a HPLC device 5. Alternatively, the testing device is a GC or GC-MS device. Instead of a testing device 6 also a solid phase extraction device may be used, or a DNA synthesizer or liquid may be supplied to a bioreactor or a DNA sequencer. The analytical instrument 1 may include a robot for liquid handling and moving labware on a working table of the analytical instrument. The analytical instrument may be part of the laboratory automation apparatus. The analytical instrument 1 includes a control unit 22 which is operatively coupled at least to the electric drive 21, the pressure sensor 3 and the valve 4. The control unit 22 may control further units of the analytical instrument such as, for example, the robot for the liquid handling. The control unit includes a processor or microprocessor and at least a storage unit. The control unit may optionally include a communication unit with a transceiver for wireless communication to an external device. The control unit 22 may be connected to a user interface for directing visual or acoustic signals to the user. The control unit 22 may receive or monitor the data from the pressure sensor 3 that correlate to the detected pressures and/or the control unit may receive or monitor the motor current MC required for advancing to and retaining the plunger rod in a certain position in the barrel of a syringe as will be explained below in FIG. 2b. The control unit is furthermore configured to control the electric drive 21 and the valve 4 in that the control unit can start/stop the electric motor and define the commutation of the motor. The control unit is configured to open or close the valve, for example by using a solenoid actuator or using a separate stepper motor for rotating the rotor of a rotary valve.

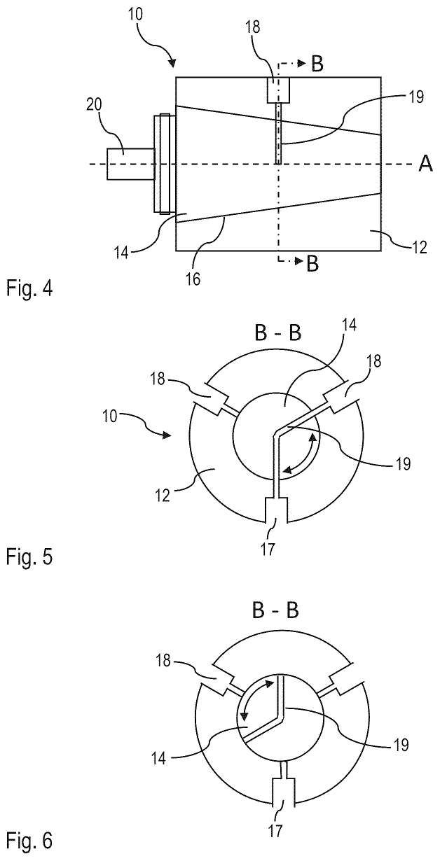

FIG. 2a presents a schematic drawing for a syringe pump 2 for use in the analytical instrument 1 with the valve 4 and pressure sensor 3 connected to an outlet 9 of a syringe 7 and the pressure sensor 3 is located between the outlet 9 and the valve 4. A three-way rotary valve 4 is presented in FIG. 2a with an inlet connected to the outlet 9 of the syringe 7 and a rotor that may select between one of the two outlets 18. Alternative options for the valve 4 may include a solenoid valve. Further details for the three-way rotary valve are presented below in FIGS. 4 to 6.

The syringe 7 in FIG. 2a includes a barrel 8 with an opening for receiving a plunger 11. The barrel 8 has a cylindrical shape and the center of the barrel defines a Z-axis. The barrel 8 defines the syringe volume V_{syri} for the installed syringe in the syringe pump. The plunger 11 can be moved along the Z-axis towards the outlet 9 of the syringe by a plunger rod 13. The plunger rod is driven by the electric drive 21. The electric drive includes the stepper motor and a gearing mechanism for gearing up or down the rotation of the drive axle of the electric motor. The gearing mechanism is operatively coupled to the plunger rod 13 for driving the plunger 11 in the syringe. The plunger 11 in FIG. 2a is located at the starting position L₀ and the valve 4 is open such that air can flow into the syringe and the pressure sensor 3 detects atmospheric pressure P1. The syringe pump 2 includes a constant volume V_{c} 23 defined by the volume of the outlet 9 of the syringe, the tubing connecting the outlet 9 to the valve 4 and the sensor 3 (in the example in FIG. 2a represented as a T-shaped connector), and the dead volumes present in the valve and sensor respectively. The syringe 7 includes a shoulder section connecting the barrel 8 to the outlet 9 and the shoulder section provides a hard stop for the movement of the plunger 11 and thereby defines the maximum travel path Lₘₐₓ 15 for the syringe.

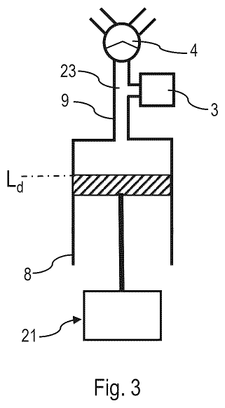

The valve 4 is closed in FIG. 2b and the electric drive 21 has advanced the plunger 11 to a pressure detection position L_{d} thereby compressing the air that was initially present in the syringe with size V_{syri} and in the constant volume V_{c} 23. The pressure sensor 3 detects the pressure P2 for the compressed air. The electric drive has advanced the plunger rod 13 according to the number of steps that were directed by the control unit 22 to the stepper motor in the electric drive. The number of steps required for advancing the plunger rod 13 thereby correlates to the pressure sweep P2−P1 that can be provided and the number of steps is thus linked to the size (for example internal diameter) of the installed syringe. A syringe with a larger diameter is presented in FIG. 3 and the same plunger movement from L₀ to L_{d} as presented in FIG. 2b will lead to a higher internal pressure P2. In the state of the art, the user may correct the controller by programming a different number of commutating steps using the user interface, or an automatic recalibration utilizes the color-coded syringes in combination with optical sensors as presented in US20210121885A1. In the example of FIG. 3, less commutating steps for the electric motor are required for reaching the same pressure level as presented in FIG. 2b. The present disclosure refers to an automatic recalibration of the analytical system or apparatus using the existing firmware as will be presented further below.

An example for the valve 4 is a rotary valve 10 as presented in FIGS. 4, 5 and 6. The rotary valve 10 includes a conical shaped rotor member 14 that fits into a conical shaped passage 16 of a stator member 12. The rotor member 14 can rotate around axis A to different rotational positions for selectively coupling an inlet 17 in the stator 12 via a channel in the rotor 14 to one of a plurality of outlets 18 of the stator. The inlet 17 may be coupled to the outlet of the syringe. The rotor member 14 includes an axle 20 that is coupled to, or may be coupled to a drive mechanism for rotating the rotor member 14 with respect to the stator member 12 to predefined angular positions. A cross sectional view B-B of the rotary valve 10 of FIG. 4 is presented in FIG. 5. The rotor 14 includes a channel 19 selectively coupling the inlet 17 via the rotor channel 19 to an outlet 18 (FIG. 5). The valve is closed when the rotor member 14 is rotated to a rotary position where the channel 19 is unable to couple the inlet 17 to one of the outlets 18. The rotor 14 and/or the stator member may be constructed from a polymeric material. Alternatively, the rotor and/or stator member may be constructed from a ceramic material.

The syringe size identification functionality will be explained for the following range of syringe sizes: 50 μl, 100 μl, 250 μl, 1000 μl, 2500 μl and 5000 μl. The constant volume V_{c} 23 occupied by the tubing, valve and sensor amounts to 74 μl in this exemplary embodiment.

TABLE 1
Syringe sizes and added volume V_{c}

| V_{syr} (μl) | V_{c} (μl) | V_{syr} + V_{c} (μl) | Ratio V_{c}/V_{syr} |
|---|---|---|---|
| 50 | 74 | 124 | 1.48 |
| 100 | 74 | 174 | 0.74 |
| 250 | 74 | 324 | 0.30 |
| 1000 | 74 | 1074 | 0.07 |
| 2500 | 74 | 2574 | 0.03 |
| 5000 | 74 | 5074 | 0.01 |

The calculation of the fraction x from the distance L_{d} travelled in the syringe is listed in Table 2

TABLE 2
Calculation of the fraction x for the movement of the plunger

| distance (mm) | L_{d} (mm) | x |
|---|---|---|
| 30 | 0 | 0 |
| 25 | 5 | 0.167 |
| 20 | 10 | 0.333 |
| 15 | 20 | 0.5 |
| 10 | 30 | 0.667 |

The theoretical pressures P2** are calculated according to the modified Boyle's equation:

$$P {2}^{* *} = P 1 ( {V}_{syr} + {V}_{c} ) / ( {V}_{syr} ( 1 - x ) + {V}_{c} )$$

The theoretical pressures P2** for the 50 μl and 5000 μl syringes are listed in the following tables for a constant volume V_{c} of 74 μl and an initial pressure P1 of 1 Bar.

TABLE 3
Calculation of the theoretical pressure P2** for a 50 μl syringe

| 50 μl/x | (V_{syr}(1 − x) + V_{c}) | P1(V_{syri} + V_{c}) | P2** (Bar) |
|---|---|---|---|
| 0 | 124.00 | 124.00 | 1.00 |
| 0.167 | 115.67 | 124.00 | 1.07 |
| 0.333 | 107.33 | 124.00 | 1.16 |
| 0.5 | 99.00 | 124.00 | 1.25 |
| 0.667 | 90.67 | 124.00 | 1.37 |

TABLE 4
Calculation of the theoretical pressure P2** for a 5000 μl syringe

| 5000 μl/x | (V_{syr}(1 − x) + V_{c}) | P1(V_{syri} + V_{c}) | P2** (Bar) |
|---|---|---|---|
| 0 | 5074.00 | 5074.00 | 1.00 |
| 0.167 | 4240.67 | 5074.00 | 1.20 |
| 0.333 | 3407.33 | 5074.00 | 1.49 |
| 0.5 | 2574.00 | 5074.00 | 1.97 |
| 0.667 | 1740.67 | 5074.00 | 2.91 |

The theoretical pressures P2** for the range of different syringe sizes is presented in the table 5 below and graphically displayed in FIG. 7:

TABLE 5
Theoretical pressure P2** (Bar) for a range of syringe sizes;

| x | 50 μl | 100 μl | 250 μl | 1000 μl | 2500 μl | 5000 μl |
|---|---|---|---|---|---|---|
| 0 | 1.00 | 1.00 | 1.00 | 1.00 | 1.00 | 1.00 |
| 0.167 | 1.07 | 1.11 | 1.15 | 1.18 | 1.19 | 1.20 |
| 0.333 | 1.16 | 1.24 | 1.35 | 1.45 | 1.48 | 1.49 |
| 0.5 | 1.25 | 1.40 | 1.63 | 1.87 | 1.94 | 1.97 |
| 0.667 | 1.37 | 1.62 | 2.06 | 2.64 | 2.84 | 2.91 |

The difference in theoretical pressures P2** between two subsequent syringe sizes for a given fraction of the plunger movement x decreases for larger syringe sizes. The theoretical pressure difference between a 100 μl and 50 μl syringe amounts 0.25 Bar for plunger movement x=0.667 whereas the theoretical pressure difference amounts 0.07 Bar between a 5000 μl and 250 μl syringe for the same plunger movement. This is affected by the fact that the ratio between the constant volume V_{c} and the syringe volume V_{syr} reduces with increasing syringe size. Once the variation in the effectively detected pressure P2, which is defined by the accuracy of the pressure sensor, is within the range of the difference in theoretical pressure P2**between two subsequent syringe sizes, then the syringe size identification functionality may not benefit from the calculated pressures P2**.

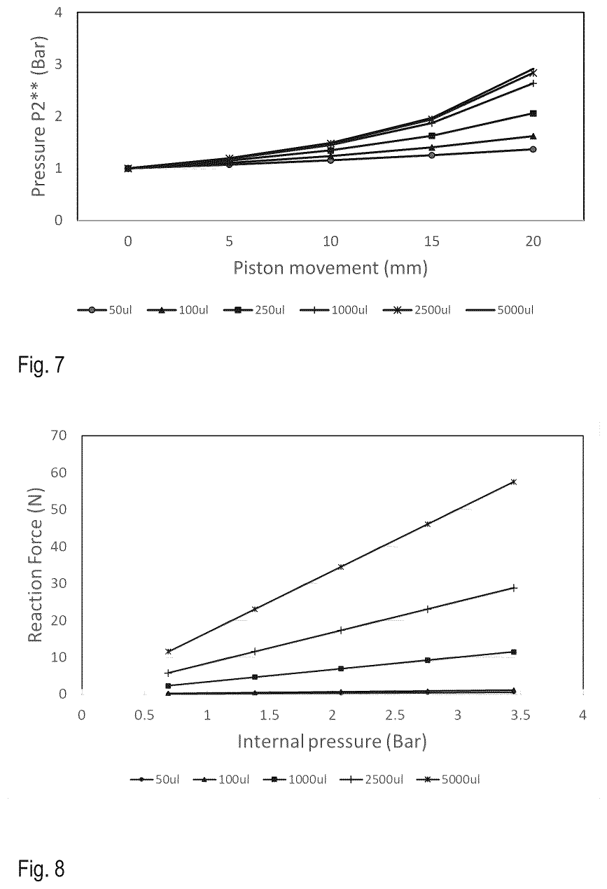

The motor current MC used for driving the stepper motor is monitored by the control unit and the motor current may be used for distinguishing between different syringe sizes as well. The plunger 11 is moved forward from the starting position L₀ to the pressure detection position L_{d} thereby compressing the air in the syringe since the valve 4 is in the closed position. The compressed air will provide a reactive force F (in Newtons) which can be calculated by multiplying the surface area of the plunger (mm²) with the pressure (1 Bar equals 0.1 N/mm²) and the results are presented in FIG. 8. The difference in reactive force between two subsequent syringe sizes increases with increasing size contrary to the difference in pressure P2** which decreases with increasing size (FIG. 7). The motor current MC required for maintaining the plunger in the pressure detection position L_{d} may be capable of distinguishing between different syringe sizes where the accuracy of the pressure sensor limits the use of the pressure calculation method.

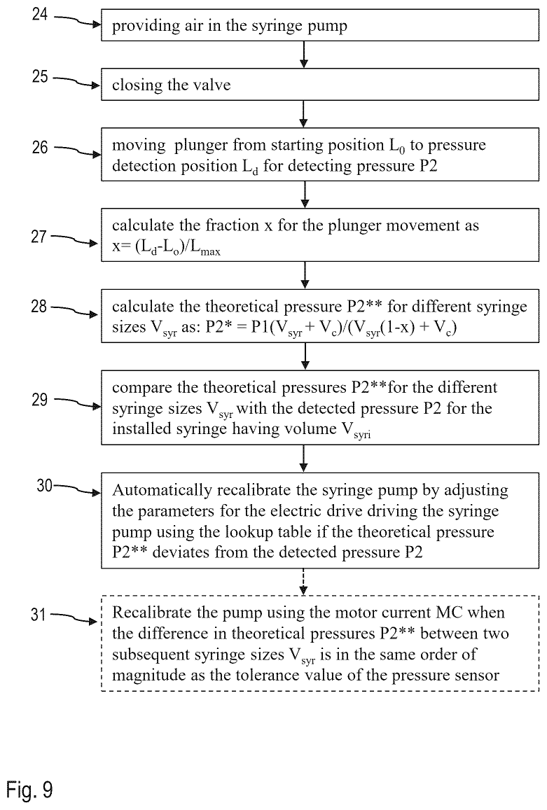

The method steps for detecting the size of a syringe in an analytical system including the syringe pump 2, the valve 4, the pressure sensor 3, the controller 22 and the electric drive 21 are presented in the block diagram in FIG. 9.
The method comprising the following steps:
Step 24: Providing air in the syringe pump at atmospheric pressure P1,
Step 25: Closing the valve,
Step 26: Moving the plunger in the syringe with volume V_{syri} using the electric drive from a starting position L₀ for detecting atmospheric pressure P1 to a pressure detection position L_{d} for detecting pressure P2 using the pressure sensor,
Step 27: Using the processor to calculate the fraction x for the plunger movement as x=(L_{d}−Lₒ)/Lₘₐₓ whereby Lₘₐₓ represents the maximum available plunger movement in the syringe,
Step 28: Using the processor to calculate the theoretical pressure P2** for the given plunger movement for different syringe sizes V_{syr} configured to be used in the analytical instrument using the same constant volume V_{c} as:

$$P {2}^{* *} = P 1 ( {V}_{syr} + {V}_{c} ) / ( {V}_{syr} ( 1 - x ) + {V}_{c} )$$

preparing a list of the theoretical pressures P2** for the different syringe sizes and store the list in a lookup table in the storage device.
Step 29: Comparing the theoretical pressures P2** for the given plunger movement for the different syringe sizes V_{syr} with the detected pressure P2 for the installed syringe having volume V_{syri}, and,
Step 30: Automatically recalibrate the syringe pump by adjusting the parameters for the electric drive driving the syringe pump using the lookup table if the theoretical pressure P2** deviates from the detected pressure P2.

The plunger in the syringe pump is advanced by a plunger rod driven by the electric drive including a stepper motor and the forward movement of the plunger rod is controlled by the number of commutating steps directed to the stepper motor thereby defining a pressure sweep P2−P1 and the number of commutating steps required for the pressure sweep is listed in the lookup table for each syringe size V_{syr}. Furthermore, adjusting the parameters for driving the syringe pump includes attributing the number of commutating steps to be directed to the electric motor to the syringe size V_{syr} where there is a match between the theoretical pressures P2** and the detected pressure P2 using the lookup table. The pressure sweep is corrected if there is a mismatch between the detected pressure and the calculated pressure. The pressure sweep may start with pressure P1 representing atmospheric pressure or, alternatively pressure P1 is for an already compressed gas in the syringe pump with a P1 value that is below P2.

The method may include an optional step:
Step 31: The method wherein the controller receives the motor current MC used by the stepper motor for keeping the plunger in the pressure detection position L_{d} and wherein the lookup table includes predefined motor current values MC* that are attributed to each syringe size V_{syr} and the syringe pump is recalibrated if a) the received motor current MC deviates from the predefined motor current value MC* and b) when the difference in theoretical pressures P2** in the lookup table between two subsequent syringe sizes V_{syr} is in the same order of magnitude as the tolerance value of the pressure sensor.

### LIST OF REFERENCE SIGNS

1 Analytical instrument
2 Syringe pump
3 Pressure sensor
4 Valve
5 HPLC
6 Waste container
7 Syringe
8 Barrel
9 Outlet
10 Rotary valve
11 Plunger
12 Stator member
13 Plunger rod
14 Rotor member
15 Maximum travel path Lₘₐₓ
16 Conical passage
17 Inlet
18 Outlet
19 Channel
20 Axle
21 Electric drive
22 Control unit, processor
23 Constant volume Vc
24 Method step for syringe
25 Method step for valve closure
26 Method step for plunger movement
27 Method step for calculation x
28 Step for pressure P2** calculation
29 Method step for comparison of pressure
30 Method step for recalibration
31 Method step for using motor current
A Rotor axis

1-16. (canceled)

17. An analytical instrument having a syringe size identification functionality comprising:
a syringe pump with an installed syringe having a size V_{syri},
an electric drive for advancing or retracting a plunger in the syringe,
a valve located downstream of the syringe,
a pressure sensor located between the syringe and the valve,
a known and constant volume V_{c} defined by the downstream volume between the syringe and the valve,
a processor operatively connected to the valve, the pressure sensor and the electric drive,
wherein the processor is configured to:
control the electric drive for moving the plunger from a position L₀ for detecting atmospheric air pressure P1 to a pressure detection position L_{d} for detecting compressed air pressure P2 using the pressure sensor,
calculate the fraction x for the plunger movement to the pressure detection position L_{d} as:
$$x = ( {L}_{d} - {L}_{0} ) / {L}_{max}$$
whereby Lₘₐₓ represents the maximum available plunger movement available in the syringe,
calculate the theoretical pressure P2* for the plunger movement to L_{d} in the installed syringe using a modified version of Boyle's law:
$$P {2}^{*} = P 1 ( {V}_{syri} + {V}_{c} ) / ( {V}_{syri} ( 1 - x ) + {V}_{c} ) ,$$
compare the theoretical pressure P2* with the detected pressure P2, and
when the theoretical pressure P2* equals the detected pressure P2 then release the analytical system with installed syringe V_{syri} for use, and
when the theoretical pressure P2* deviates from the detected pressure P2 then compare the detected pressure P2 with a lookup table stored in a storage device of the processor, the lookup table comprising theoretical pressures P2** attributed to a list of different syringe sizes V_{syr} to be used in the syringe pump, and recalibrate the syringe pump by adjusting the parameters for the electric drive according to the syringe size V_{syr} where there is a match between the theoretical pressures P2** from the lookup table and the detected pressure P2.

18. The analytical instrument according to claim 17 wherein the theoretical pressures P2** attributed to a list of different syringe sizes V_{syr} are calculated according to the modified version of Boyle's law as: P2**=P1(V_{syr}+V_{c})/(V_{syr}(1−x)+V_{c}).

19. The analytical instrument according to claim 18, wherein the plunger in the syringe is advanced by a plunger rod driven by the electric drive comprising a stepper motor.

20. The analytical instrument according to claim 19, wherein the forward movement of the plunger rod is controlled by the number of commutating steps directed to the stepper motor thereby defining a pressure sweep P2−P1 and the number of commutating steps required for the pressure sweep is listed in the lookup table for each syringe size V_{syr}.

21. The analytical instrument according to claim 17, wherein recalibration comprises attributing the number of commutating steps of the electric motor to the syringe size V_{syr} where there is a match between the theoretical pressures P2** and the detected pressure P2.

22. The analytical instrument according to claim 21, wherein the known constant volume V_{c} (23) is defined by the tubing or connectors connecting the syringe to the valve, the dead volume in the valve and the dead volume in the pressure sensor.

23. The analytical instrument according to claim 21, which is automatically recalibrated when the theoretical pressure P2* deviates from the detected pressure P2

24. The analytical instrument according to claim 21, wherein the syringe pump is filled with air for the syringe size identification testing.

25. The analytical instrument according to claim 21, wherein the processor monitors the motor current MC used by the stepper motor for keeping the plunger in the pressure detection position L_{d}.

26. The analytical instrument according to claim 25, wherein the lookup table comprises predefined motor current values MC* that are attributed to each syringe size V_{syr} and the syringe pump is recalibrated when the received motor current MC deviates from the predefined motor current value MC* and when the difference in theoretical pressures P2** in the lookup table between two subsequent syringe sizes V_{syr} is in the same order of magnitude as the tolerance value of the pressure sensor.

27. The analytical instrument according to claim 26, wherein recalibration the syringe pump comprises attributing the number of commutating steps of the electric motor to the syringe size V_{syr} where there is a match between the predefined motor current value MC* and the received motor current value MC.

28. The analytical instrument according to claim 26, wherein the syringe size identification testing in the is periodically performed or performed upon replacing the syringe in the syringe pump.

29. A method for detecting the size of a syringe in an analytical instrument comprising:
a syringe pump with an installed syringe having a volume V_{syri},
a valve located downstream of the syringe,
a pressure sensor located between the valve and the syringe,
a known and constant volume V_{c} representing the downstream volume between the syringe and the valve,
an electric drive for advancing or retracting a plunger in the syringe, and
a controller with a processor for controlling the analytical instrument;
the method comprising the following steps:
providing air in the syringe pump at atmospheric pressure P1;
closing the valve;
moving the plunger in the syringe with volume V_{syri} using the electric drive from a starting position L₀ for detecting atmospheric pressure P1 to a pressure detection position L_{d} for detecting pressure P2 using the pressure sensor;
using the processor to calculate the fraction x for the plunger movement as x=(L_{d}−L₀)/Lₘₐₓ whereby Lₘₐₓ represents the maximum available plunger movement in the syringe;
using the processor to calculate the theoretical pressure P2** for the given plunger movement for different syringe sizes V_{syr} configured to be used in the analytical instrument (1) using the same constant volume V_{c} using a modified version of Boyle's law as:
$$P {2}^{* *} = P 1 ( {V}_{syr} + {V}_{c} ) / ( {V}_{syr} ( 1 - x ) + {V}_{c} ) ;$$
preparing a list of the theoretical pressures P2** for the different syringe sizes and store the list in a lookup table in a storage device of the controller;
comparing the theoretical pressures P2** for the given plunger movement for the different syringe sizes V_{syr} with the detected pressure P2 for the installed syringe having volume V_{syri}; and
automatically recalibrate the syringe pump by adjusting the parameters for the electric drive driving the syringe pump using the lookup table when the theoretical pressure P2** deviates from the detected pressure P2.

30. The method according to claim 29, wherein the plunger in the syringe is advanced by a plunger rod driven by the electric drive comprising a stepper motor and the forward movement of the plunger rod is controlled by the number of commutating steps directed to the stepper motor thereby defining a pressure sweep P2−P1 and the number of commutating steps required for the pressure sweep is listed in the lookup table for each syringe size V_{syr}.

31. The method according to claim 30, wherein adjusting the parameters for driving the syringe pump comprises attributing the number of commutating steps of the electric motor to the syringe size V_{syr} where there is a match between the theoretical pressures P2** and the detected pressure P2 using the lookup table thereby correcting the pressure sweep.

32. The method according to claim 31, wherein the controller is configured to issue an acoustic and/or visual alarm when the theoretical pressure P2** deviates from the detected pressure P2 and/or the controller is configured to issue an acoustic and/or visual notification when the theoretical pressure P2** equals the detected pressure P2.

33. The method according to claim 31, wherein the processor of the controller monitors the motor current MC used by the stepper motor for keeping the plunger in the pressure detection position L_{d} and wherein the lookup table comprises predefined motor current values MC* that are attributed to each syringe size V_{syr} and the syringe pump is recalibrated when the received motor current MC deviates from the predefined motor current value MC* and when the difference in theoretical pressures P2** in the lookup table between two subsequent syringe sizes V_{syr} is in the same order of magnitude as the tolerance value of the pressure sensor.

34. The method according to claim 33 wherein recalibration the syringe pump comprises attributing the number of commutating steps for the electric motor to the syringe size V_{syr} where there is a match between the predefined motor current value MC* and the received motor current value MC.

35. A computer program for detecting the size of a syringe in an analytical system, the computer program when executed by the processor that is part of the analytical instrument is adapted to execute the method of claim 29.
